(19) United States
(12) Patent Application Publication
(10) Pub. No.: US 2024/0393133 A1
(43) Pub. Date: Nov. 28, 2024

(54) Method for Updating Digital Map Material for Motor Vehicles

(71) Applicant: Bayerische Motoren Werke Aktiengesellschaft, Muenchen (DE)

(72) Inventors: Alexander BUSCH, Planegg, DE (US); Evgeni GENENDER, Hohenkammer, DE (US); Martin GORLT, Markt Indersdorf, DE (US); Tobias RASCH, Muenchen, DE (US)

(21) Appl. No.: 18/637,687

(22) Filed: Apr. 17, 2024

(30) Foreign Application Priority Data
May 17, 2023 (DE) 10 2023 113 084.6

(51) Int. Cl. G01C 21/00

(52) U.S. Cl. CPC G01C 21/3859

(57) ABSTRACT

A method for updating digital map material for motor vehicles includes the following steps: during operation of a motor vehicle, continuously detecting whether the motor vehicle is currently located on a road or a facility for stationary traffic; if it is detected that the motor vehicle has driven from a road onto a facility for stationary traffic, determining a departure point at which the motor vehicle has left the road and driven onto the facility for stationary traffic; updating the digital map material based on the determined departure point; and providing the updated digital map material.

### CROSS REFERENCE TO RELATED APPLICATION

This application claims priority under 35 U.S.C. § 119 from German Patent Application No. DE 10 2023 113 084.6, filed 2023 May 17, the entire disclosure of which is herein expressly incorporated by reference.

### BACKGROUND AND SUMMARY

The present invention relates to a method for updating digital map material for motor vehicles and in particular a method, using which digital map material can be updated based on a recognized entry to a facility for stationary traffic, for example a parking area, which comprises at least one charging station for electric vehicles.

Digital map material is understood in general as the creation, processing, or operative application of maps in digital form, i.e. map material present in digital form. In this case, for example navigation systems of a motor vehicle make use of digital map material for route planning from a present location or a selected starting location to a desired destination point.

A facility for stationary traffic is furthermore understood as facilities or areas on which motor vehicles can be stopped or parked and/or on which motor vehicles not ready to drive can be stored. One example of such facilities for stationary traffic is parking areas.

If a user or driver of a motor vehicle wishes to drive onto a facility for stationary traffic, for example since it has at least one charging station for electric vehicles or for charging an electric vehicle, navigation systems typically guide the user as close as possible to the corresponding facility for stationary traffic. However, it can be the case here that an access ramp to the corresponding facility for stationary traffic is arranged further away and the facility for stationary traffic cannot be driven onto at all from the road which extends closest to the facility for stationary traffic.

A method for registering a movement of a motor vehicle in a parking garage having at least one first parking level and one second parking level, which are connected by at least one access ramp, is known from document DE 10 2014 111 574 A1, wherein, while the motor vehicle drives on the access ramp, at least one feature characterizing the access ramp is detected using a motor vehicle-side unit and a change of the parking levels which has taken place due to the movement of the motor vehicle is recognized on the basis of the feature.

An object of embodiments of the invention is to provide a method, based on which a route plan toward a facility for stationary traffic can be optimized.

This object is achieved by the subject matter of the independent claims. Further advantageous refinements are the subject matter of the dependent claims.

According to one embodiment of the invention, this object is achieved by a method for updating digital map material for motor vehicles, wherein the method comprises continuously detecting, during operation of the motor vehicle, whether the motor vehicle is currently located on a road or on a facility for stationary traffic, determining a departure point at which the motor vehicle has departed from the road and has driven onto the facility for stationary traffic; if it is detected that the motor vehicle has driven from a road onto a facility for stationary traffic, updating the digital map material based on the determined departure point and providing the updated digital map material.

A departure point is understood in this case as a point or a position at which an access ramp to the corresponding facility for stationary traffic begins or at which motor vehicles have to depart from a road in order to reach the facility for stationary traffic.

A method is therefore specified which is designed such that digital map material can be updated based on experiential values or historic data, in particular can be expanded with information regarding access ramps to facilities for stationary traffic.

Overall, a method is therefore specified, based on which route planning toward a facility for stationary traffic can be optimized.

The method can furthermore comprise a step here of determining whether the motor vehicle is about to drive onto the facility for stationary traffic, wherein the steps of continuously detecting whether the motor vehicle is currently located on a road or a facility for stationary traffic, determining the departure point, and updating the digital map material are only executed if it is determined that the motor vehicle is about to drive onto a facility for stationary traffic.

The statement that the motor vehicle is about to drive onto a facility for stationary traffic means here that the motor vehicle will drive onto the facility for stationary traffic within a fixed or defined period of time, for example within the next 2 to 5 minutes, which can be determined, for example, based on route plans or inputs into a navigation system.

This has the advantage that the corresponding updating of the digital map material is only executed when the motor vehicle actually drives onto the facility for stationary traffic, which enables resources required for this purpose, such as memory and/or processor capacities, to be saved and a corresponding data transfer to be minimized.

Moreover, the step of updating the digital map material can comprise updating route plans on the facility for stationary traffic or toward the facility for stationary traffic. In particular, stored and/or proposed routes or route plans, i.e. navigation guides can be updated based on the determined departure point. In this way, a navigation toward or on the facility for stationary traffic can be optimized.

In one embodiment, the facility for stationary traffic comprises at least one charging station for electric vehicles, wherein the method furthermore comprises a step of detecting whether the motor vehicle has been connected to one of the at least one charging stations and wherein the step of updating the digital map material is only executed when it is detected that the motor vehicle has been connected to one of the at least one charging stations.

A charging station for electric vehicles is understood here as a charging station or electricity charging station for charging an electric or plug-in hybrid vehicle with electric energy.

The statement that the facility for stationary traffic comprises at least one charging station furthermore means here that at least one charging station is formed or available on the facility for stationary traffic.

It can thus be ensured that a driver or user of the motor vehicle is able to reach a charging station based on a route plan or navigation guide and is not automatically guided to a road extending closest to the corresponding facility for stationary traffic.

A further embodiment of the invention also specifies a method for navigating a motor vehicle on a facility for stationary traffic, wherein the method comprises providing digital map material for navigating the motor vehicle, updating the provided digital map material by way of an above-described method for updating digital map material, and navigating the motor vehicle on the facility for stationary traffic based on the updated digital map material.

A method for navigating a motor vehicle on a facility for stationary traffic is therefore specified, which is based on a method, based on which a route plan toward a facility for stationary traffic can be optimized. In particular, the method is based on a method which is designed such that digital map material can be updated based on experiential values or historic data, in particular can be expanded with information with regard to access ramps to facilities for stationary traffic.

A further embodiment of the invention furthermore also specifies a system for updating digital map material for motor vehicles, wherein the system comprises a first detection unit, which is designed to continuously detect during operation of a motor vehicle whether the motor vehicle is currently located on a road or a facility for stationary traffic, a first determination unit, which is designed to determine a departure point at which the motor vehicle has departed from the road and has driven onto the facility for stationary traffic if it is detected that the motor vehicle has driven from a road onto a facility for stationary traffic, and an update unit, which is designed to update the digital map material based on the departure point.

A system is therefore specified, based on which a route plan toward a facility for stationary traffic can be optimized. In particular, a system is specified which is designed such that digital map material can be updated based on experiential values or historic data, in particular can be expanded with information with regard to access ramps to facilities for stationary traffic.

The system can furthermore comprise a second determination unit here, which is designed to register whether the motor vehicle is about to drive onto the facility for stationary traffic, wherein the system is designed such that the detection by the first detection unit as to whether the motor vehicle is currently located on a road or a facility for stationary traffic, the determination of the departure point by the determination unit, and the update of the digital map material by the update unit are only executed when it is determined by the second determination unit that the motor vehicle is about to drive onto a facility for stationary traffic. This has the advantage that the corresponding updating of the digital map material is only executed when the motor vehicle actually drives onto the facility for stationary traffic, as a result of which resources required for this purpose, such as memory and/or processor capacities, can be saved and a corresponding data transfer can be minimized.

Moreover, the updating unit can be designed to update route plans on the facility for stationary traffic. In particular, stored and/or proposed routes or route plans, i.e. navigation guides, can be updated based on the determined departure point. Navigation toward or on the facility for stationary traffic can be optimized in this way.

In one embodiment, the facility for stationary traffic comprises at least one charging station for electric vehicles, wherein the system furthermore comprises a second detection unit, which is designed to detect whether the motor vehicle has been connected to one of the at least one charging stations, and wherein the updating unit is designed to update the digital map material only when it is detected that the motor vehicle has been connected to one of the at least one charging stations. It can thus also be ensured that a driver or user of the motor vehicle can actually reach a charging station based on a route plan or navigation guide and is not automatically guided to a road extending closest to the corresponding facility for stationary traffic.

Moreover, a further embodiment of the invention also specifies a system for navigating a motor vehicle on a facility for stationary traffic, wherein the system comprises a provision unit, which is designed to provide digital map material for navigating the motor vehicle, an update unit, which is designed to update the digital map material, wherein the update unit comprises an above-described system for updating digital map material for motor vehicles, and a navigation unit, which is designed to navigate the motor vehicle on the facility for stationary traffic based on the updated digital map material.

A system for navigating a motor vehicle on a facility for stationary traffic is therefore specified, which is based on a system, based on which a route plan toward a facility for stationary traffic can be optimized. In particular, the system is based on a system which is designed such that digital map material can be updated based on experiential values or historic data, in particular can be expanded with information with regard to access ramps to facilities for stationary traffic.

A further embodiment of the invention additionally also specifies a computer program product comprising instructions, which, upon the execution of the program by a computer, prompt the latter to carry out an above-described method for updating digital map material for motor vehicles.

The computer program product has the advantage here that it is designed to carry out a method based on which a route plan toward a facility for stationary traffic can be optimized. In particular, the computer program product is designed to carry out a method which is designed such that digital map material can be updated based on experiential values or historic data, in particular can be expanded with information with respect to access ramps to facilities for stationary traffic.

In summary, it can be stated that the present invention specifies a method for updating digital map material for motor vehicles and in particular a method, using which digital map material can be updated based on a recognized entry to a facility for stationary traffic.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a flow chart of a method for updating digital map material for motor vehicles according to embodiments of the invention;

FIG. 2 is a schematic block diagram of a system for updating digital map material for motor vehicles according to embodiments of the invention.

### DETAILED DESCRIPTION OF THE DRAWINGS

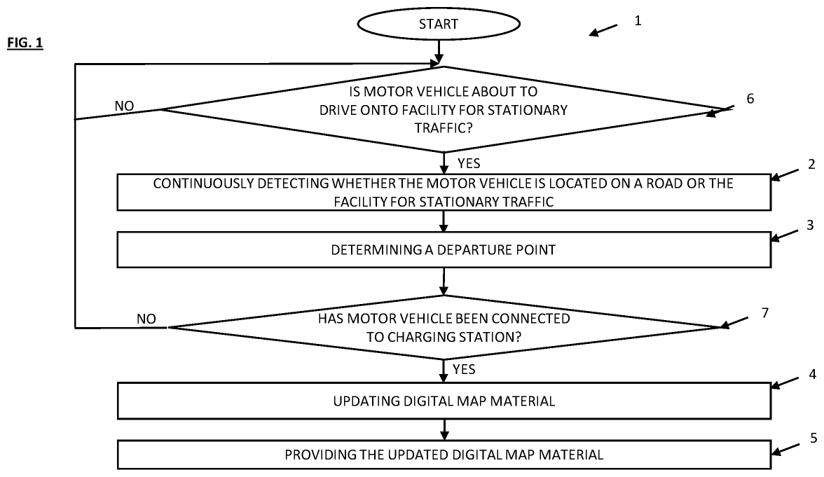

FIG. 1 shows a flow chart of a method for updating digital map material for motor vehicles 1 according to embodiments of the invention.

If a user or driver of a motor vehicle wishes to drive onto a facility for stationary traffic, for example since it comprises at least one charging station for electric vehicles, navigation systems usually guide the user so they can come as close as possible to the corresponding facility for stationary traffic. However, it can be the case here that an access ramp to the corresponding facility for stationary traffic is arranged further away and the facility for stationary traffic cannot be driven onto at all from the road which extends closest to the facility for stationary traffic.

FIG. 1 shows for this purpose a method 1, which comprises a step 2 of continuously detecting during operation of the motor vehicle whether the motor vehicle is currently located on a road or a facility for stationary traffic, a step 3 of determining a departure point at which the motor vehicle has departed from the road and has driven onto the facility for stationary traffic; if it is detected in step 2 that the motor vehicle has driven from a road onto a facility for stationary traffic, a step 4 of updating the digital map material based on the determined departure point, and a step 5 of providing the updated digital map material.

A method 1 is therefore specified, which is designed such that digital map material can be updated based on experiential values or historic data, in particular can be expanded with information with respect to access ramps to facilities for stationary traffic.

Overall, a method 1 is therefore specified, based on which a route plan toward a facility for stationary traffic can be optimized.

Step 3 can comprise transmitting information about a route which the motor vehicle has driven in order to reach the facility for stationary traffic, to a computing unit, for example a backend server, wherein the transmitted information can represent, for example, the last 100 m to 500 m before the motor vehicle drove onto the facility for stationary traffic, and wherein the departure point can be determined in the computing unit based on the transmitted information and corresponding digital map material.

Step 2 of continuously detecting whether the motor vehicle is currently located on a road or a facility for stationary traffic can furthermore be based, for example, on sensor data, for example data registered by surroundings sensors of the motor vehicle, and/or digital map material.

Step 2 of continuously detecting whether the motor vehicle is currently located on a road or a facility for stationary traffic can moreover take place continuously or else at certain points in time, for example at predetermined, in particular regular time intervals.

The facility for stationary traffic can be in particular a parking area, for example a multilevel parking area, wherein information about the height at which the motor vehicle was located at the point in time at which it drove onto the parking area can also be registered and incorporated into the determination of the departure point.

As FIG. 1 shows, the method furthermore comprises a step 6 of determining whether the motor vehicle is about to drive onto the facility for stationary traffic, and wherein steps 3, 4 and 5 of continuously detecting whether the motor vehicle is currently located on a road or a facility for stationary traffic, determining the departure point, and updating the digital map material are only executed when it is determined that the motor vehicle is about to drive onto a facility for stationary traffic.

Step 6 of determining whether the motor vehicle is about to drive onto the facility for stationary traffic can be based, for example, on a route plan or inputs into a navigation system.

As FIG. 1 shows, the method according to the embodiments of FIG. 1 returns to step 2 if it is determined in step 6 that the motor vehicle is not about to drive onto the facility for stationary traffic, for example within the next 2 to 5 minutes.

Moreover, step 4 of updating the digital map material comprises updating route plans, i.e. possible routes provided by a navigation system.

According to the embodiments of FIG. 1, the facility for stationary traffic comprises at least one charging station for charging electric vehicles, wherein the method 1 furthermore comprises a step 7 of detecting whether the motor vehicle has been connected to one of the at least one charging stations, and wherein step 4 of updating the digital map material is executed when it is detected that the motor vehicle has been connected to one of the at least one charging stations.

Step 7 of detecting can be based here, for example, on data provided by a charging controller.

As FIG. 1 shows, the method according to the embodiments of FIG. 1 returns to step 2 if it is determined in step 7 that the motor vehicle has not been connected to one of the at least one charging stations.

An entry to a charging station can thus be identified precisely by the illustrated method 1.

Moreover, still further information, such as a plug type used or a charging power, can also be registered and incorporated into the update of the digital map material.

Based on the correspondingly updated digital map material, a route plan or navigation guide can then be optimized and the motor vehicle can be guided, for example, as precisely as possible to a selected charging station.

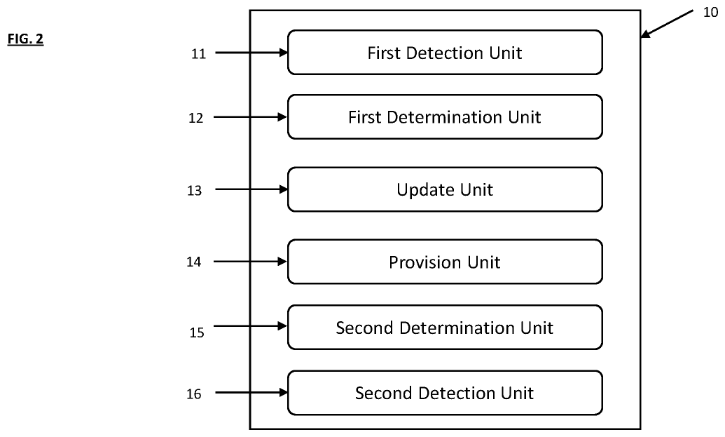

FIG. 2 shows a schematic block diagram of a system for updating digital map material for motor vehicles 10 according to embodiments of the invention.

As FIG. 2 shows, the system 10 comprises a first detection unit 11 here, which is designed to continuously detect during operation of a motor vehicle whether the motor vehicle is currently located on a road or a facility for stationary traffic, a first determination unit 12, which is designed to determine a departure point, at which the motor vehicle has departed from the road and driven onto the facility for stationary traffic, if it is detected that the motor vehicle has driven from a road onto a facility for stationary traffic, an update unit 13, which is designed to update the digital map material based on the departure point, and a provision unit 14, which is designed to provide the updated digital map material.

The first detection unit, the first determination unit, and the update unit can each be implemented here based on a code stored in a memory and executable by a processor.

The provision unit can moreover in particular be a transmitter which is designed to transmit corresponding data, i.e. digital map material.

As FIG. 2 shows, the system 10 furthermore comprises a second determination unit 15, which is designed to register whether the motor vehicle is about to drive onto the facility for stationary traffic, wherein the system 10 is designed such that the continuous detection by the first detection unit as to whether the motor vehicle is currently located on a road or a facility for stationary traffic, the determination of the departure point by the determination unit, and the update of the digital map material by the update unit are only carried out when it is determined by the second determination unit 15 that the motor vehicle is about to drive onto a facility for stationary traffic.

The second determination unit can be implemented here based on corresponding sensors, for example surroundings sensors of the motor vehicle, and/or a code stored in a memory and executable by a processor.

Moreover, the update unit 13 is in turn designed to update corresponding route plans.

According to the embodiments of FIG. 2, the facility for stationary traffic in turn comprises at least one charging station for electric vehicles, wherein the system 10 furthermore comprises a second detection unit 16, which is designed to detect whether the motor vehicle has been connected to one of the at least one charging stations, and wherein the update unit 13 is designed to update the digital map material when it is detected that the motor vehicle has been connected to one of the at least one charging stations.

The illustrated system 10 is moreover designed to carry out an above-described method for updating digital map material for motor vehicles.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 method
2 method step
3 method step
4 method step
5 method step
6 method step
7 method step
10 system
11 first detection unit
12 first determination unit
13 update unit
14 provision unit
15 second determination unit
16 second detection unit

What is claimed is:

1. A method for updating digital map material for motor vehicles, the method comprising the steps of:
during operation of a motor vehicle, continuously detecting whether the motor vehicle is currently located on a road or a facility for stationary traffic;
when it is detected that the motor vehicle has driven from a road onto a facility for stationary traffic, determining a departure point at which the motor vehicle has departed from the road and driven onto the facility for stationary traffic;
updating the digital map material based on the determined departure point; and
providing the updated digital map material.

2. The method according to claim 1, further comprising a step of:
determining whether the motor vehicle is about to drive onto the facility for stationary traffic, and
wherein the steps of continuously detecting whether the motor vehicle is currently located on a road or a facility for stationary traffic, determining the departure point, and updating the digital map material are only executed when it is determined that the motor vehicle is about to drive onto a facility for stationary traffic.

3. The method according to claim 1, wherein the step of updating the digital map material comprises:
updating route plans on the facility for stationary traffic.

4. The method according to claim 1, wherein
the facility for stationary traffic comprises at least one charging station for electric vehicles,
and wherein the method further comprises a step of:
detecting whether the motor vehicle has been connected to one of the at least one charging stations, and
wherein the step of updating the digital map material is executed when it is detected that the motor vehicle has been connected to one of the at least one charging stations.

5. A method for navigating a motor vehicle on a facility for stationary traffic, the method comprising the steps of:
providing digital map material for navigating the motor vehicle;
updating the provided digital map material by:
during operation of a motor vehicle, continuously detecting whether the motor vehicle is currently located on a road or a facility for stationary traffic;
when it is detected that the motor vehicle has driven from a road onto a facility for stationary traffic, determining a departure point at which the motor vehicle has departed from the road and driven onto the facility for stationary traffic;
updating the digital map material based on the determined departure point; and
providing the updated digital map material; and
navigating the motor vehicle on the facility for stationary traffic based on the updated digital map material.

6. A system for updating digital map material for motor vehicles, the system comprising:
a first detection unit configured to continuously detect during operation of a motor vehicle whether the motor vehicle is currently located on a road or a facility for stationary traffic;
a first determination unit configured to determine a departure point at which the motor vehicle has departed from the road and has driven onto the facility for stationary traffic when it is detected that the motor vehicle has driven from a road onto a facility for stationary traffic;
an update unit configured to update the digital map material based on the departure point; and
a provision unit configured to provide the updated digital map material.

7. The system according to claim 6, further comprising:
a second determination unit configured to determine whether the motor vehicle is about to drive onto the facility for stationary traffic, and
wherein the system is configured such that the continuous detection by the first detection unit as to whether the motor vehicle is currently located on a road or a facility for stationary traffic, the determination of the departure point by the determination unit, and the update of the digital map material by the update unit are only executed when it is determined by the second determination unit that the motor vehicle is about to drive onto a facility for stationary traffic.

8. The system according to claim 6, wherein the update unit is configured to update route plans on the facility for stationary traffic.

9. The system according to claim 6, wherein
the facility for stationary traffic comprises at least one charging station for electric vehicles,
wherein the system further comprises:
a second detection unit configured to detect whether the motor vehicle has been connected to one of the at least one charging stations, and wherein the update unit is configured to update the digital map material when it is detected by the second detection unit that the motor vehicle has been connected to one of the at least one charging stations.

10. A system for navigating a motor vehicle on a facility for stationary traffic, the system comprising:
a provision unit configured to provide digital map material for navigating the motor vehicle;
an update unit configured to update the digital map material, wherein the update unit comprises a system for updating digital map material for motor vehicles according to claim 6; and
a navigation unit configured to navigate the motor vehicle on the facility for stationary traffic based on the updated digital map material.

11. A computer product comprising a non-transitory computer readable medium having stored thereon program code which, when executed by a computer, carries out the acts of:
during operation of a motor vehicle, continuously detecting whether the motor vehicle is currently located on a road or a facility for stationary traffic;
when it is detected that the motor vehicle has driven from a road onto a facility for stationary traffic, determining a departure point at which the motor vehicle has departed from the road and driven onto the facility for stationary traffic;
updating the digital map material based on the determined departure point; and
providing the updated digital map material.
